(19) United States
(12) Patent Application Publication
(10) Pub. No.: US 2014/0207864 A1
(43) Pub. Date: Jul. 24, 2014

(54) Method for Maintaining a Parental Control Online Profile for a Child

(71) Applicant: Rekha Meena, Sunnyvale, CA (US)

(72) Inventor: Rekha Meena, Sunnyvale, CA (US)

(21) Appl. No.: 14/074,488

(22) Filed: Nov. 7, 2013

Related U.S. Application Data
(60) Provisional application No. 61/755,844, filed on Jan. 23, 2013.

(51) Int. Cl. H04L 29/08

(52) U.S. Cl. CPC H04L 67/306
USPC 709/204

(57) ABSTRACT

A method for maintaining a parental control online profile for a child is executed through a user account and a social network system, wherein the social network system includes a plurality of user accounts. The user account can access at least one child profile, and the at least one child profile is completed a plurality of photographs which creates a timeline for the at least one child profile. The user account is able select and execute a plurality of additional features for the at least one child profile, where each of the plurality of additional features associates with different output. Even though the parents control the at least one child profile, once the child reaches a predetermine age, the child is able to fully control his or her own child profile.

The current application claims a priority to the U.S. Provisional Patent application Ser. No. 61/755,844 filed on Jan. 23, 2013.

### FIELD OF THE INVENTION

The present invention relates generally to a social network website. More specifically, the present invention is a social website with a plurality of child profiles which are created and controlled by parents since pregnancy until the respective children reaches a predetermine age. Once the children reaches the predetermine age, the children get to take over the plurality of child profiles.

### BACKGROUND OF THE INVENTION

Even though there are many different social networking sites are available in the present society, these social networking sites lack the continuous coverage for users with respect to their early ages. For example, most people do not have enough information regarding their childhood within the social network sites because they were not able to access the social network sites during their early ages as the social networking sites are not geared toward the young generations. In general, social networking sites and other online services of the internet offer a mix of features and tools. These sites and their features are designed to keep the users clicking on the advertisement-supported page of the sites. Social networking sites have shown potential to become the place on the internet where many people spend most their time, thus making these sites the main entry point for online activity.

It is therefore objective of the present invention to provide a social network which allows the users to continuously keep track of a childhood of their children. The present invention is accessed and maintained by a user, which can be a parent, a legal guardian, or a foster parent, so that each child can have complete a child profile starting from the pregnancy. The Child Profiles are maintained by the user until children become responsible enough to manage their profiles. Child profiles are photo based and can include variety of photos of including, but not limited to, the pregnant mother, infancy, childhood, and adolescence. For example, the users of the child profile are able to upload photos regarding pre-pregnancy, pregnancy, post-pregnancy, the first smile, the first move, the first birthday and subsequence birthdays, the school years, and many other important instances. Since the user can keep photos and family photos within the child profiles of the present invention, the maintenance of the photos is not difficult for the user, where the user can maintain every moment since pregnancy till further. After the child profile is matured, the user will no longer control the child profile, and the respective child will be the owner of child's profile.

The present invention allows the user to see his/her child's activity respectively to month or year as he/she wants to observe and maintain child's sports activity, school performance, health related problem and their solution, and health comment by other users, and suggestion by other users. The user can also add child's profile to a family history so that the records of the child can be stored within family generation with regards to appearance at different stage of life. The present invention allows the children to grow up into adults and when they have their own children, then they can look back into their past through the present invention and compare them self with their own children. The users can make online announcement for their children's birthdays and send invites to the children's friends and their parents.

### BRIEF DESCRIPTION OF THE DRAWINGS

FIG. 1 is a flow chart illustrating the basic overall method of the present invention.

FIG. 2 is a flow chart illustrating the process for the request of interaction of the present invention.

FIG. 3 is a flow chart illustrating the process for the secondary user account request of the present invention.

FIG. 4 is a flow chart illustrating the process for the group feature of the present invention.

FIG. 5 is a flow chart illustrating the basic process of selecting the view photo feature of the present invention.

FIG. 6 is a flow chart illustrating the basic process of selecting the slideshow feature of the present invention.

FIG. 7 is a flow chart illustrating the basic process of selecting the event feature of the present invention.

FIG. 8 is a flow chart illustrating the basic process of selecting the photo editing feature of the present invention.

FIG. 9 is a flow chart illustrating the basic process of selecting the monthly progress feature of the present invention.

FIG. 10 is a flow chart illustrating the basic process of selecting the compare growth feature of the present invention.

FIG. 11 is a flow chart illustrating the basic process of selecting the daily diary feature of the present invention.

FIG. 12 is a flow chart illustrating the basic process of selecting the upload feature of the present invention.

### DETAIL DESCRIPTIONS OF THE INVENTION

All illustrations of the drawings are for the purpose of describing selected versions of the present invention and are not intended to limit the scope of the present invention.

The present invention is a method for maintaining a parental control online child profile for a child through a social network so that the child profiles are able to interact with each other through a plurality of user accounts. The child profiles are maintained by parents till the children become responsible to maintain their profiles. When the children get to a first predetermine age, the children will be granted partial control of their profiles in such way that the parents are still able to oversee the child profiles. When the children get to a second predetermine age, the children will be granted full control of their profiles and the parents will no longer have control over the children's profiles. The plurality of user accounts of the present invention includes a user account and other user accounts, where each of the other user accounts of the present invention is similarly managed to the user account. Moreover, the present invention is hereinafter explained with regard to the user account, but the same process can be executed by each of the other user accounts.

In order for someone to access the present invention, a user of the present invention needs to create the user account through a sign-up process of the present invention or log-in with an existing social network profile so that control software of the present invention grants access to the present invention. In order to create the user account, a user needs to provide an email address and a password. Once the user uploads the email and the password, the control software sends an activation notification to the email address. Then the user can access the present invention through the activation notification, where the control software prompts the user to create a user account with general information. As for the general information, the user needs to upload a full user name, a user gender, a user birthday, a contact number, the email, and a user image.

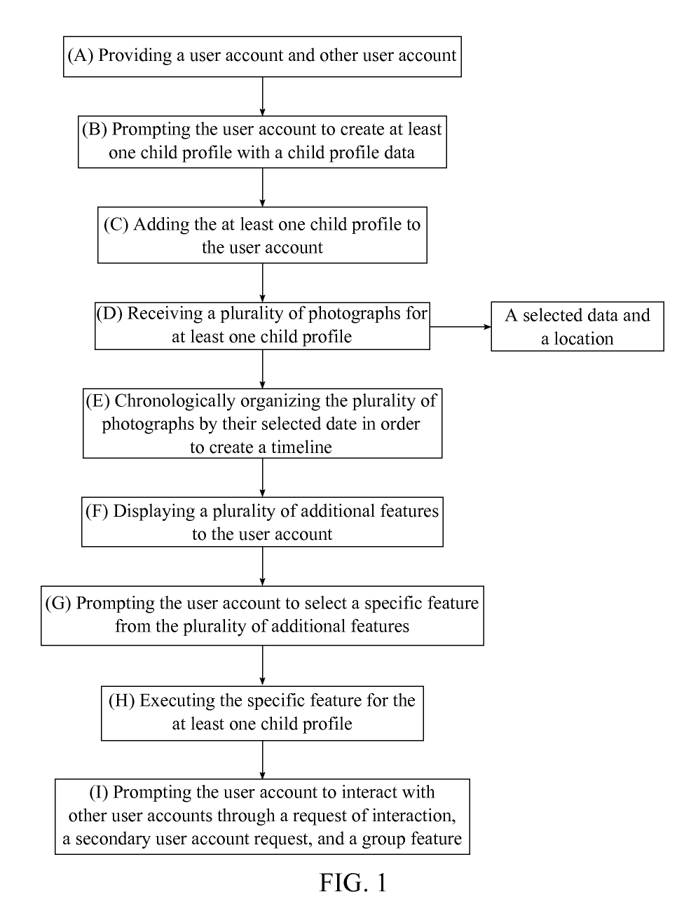

In reference to FIG. 1, once the control software finalizes the general information with respect to the user account, the control software then prompts the user account to create at least one child profile with a child profile data. The child profile data of the at least one child profile includes a child name, a child gender, a child nickname, and a child birthday. The user can also chose a background theme for the at least one child profile from a plurality of standard theme images or a customize theme image. The creation of the at least one child profile can be carried out by the user account anytime with regard to the age of the child. For example, the user account can create the at least one child profile before the child is born or after the child is born. After the at least one child profile is created by the control software, the at least one child profile is added to the user account. Then the user account can upload a plurality of photographs for the at least one child profile, wherein the each of the plurality of photographs includes a selected date and a geographical location. The control software then receives the plurality of photographs with the selected date and the geographical location. Then the plurality of photographs is chronologically organized by their selected date in order to create a timeline for the at least one child profile. The timeline of the present invention is one of the important features as the timeline illustrates growth of the child with respect to the plurality of photographs and the selected date. The timeline keeps the plurality of photographs in an organized manner so that the user account can always refer back to the time and location of each of the plurality of photographs. The timeline is always displayed to the user account every time the user account access the present invention through the email address and the password, where the timeline can narrow down into years, months, date, and any other combination of thereof. If the user account desires, the user account can post a comment and/or execute a resemble-feature of the present invention for each of the plurality of photographs. More specifically, the user account can post the comment right below the respective photographs as the present invention provides a comment. In order to execute the resemble-feature, the user account needs to select the resembles-feature which then prompts the user account to select a resemble relationship from a drop down list and upload a resemble image file. Once the resemble relationship is selected and the resemble image file is uploaded, the control software executes the resemble-feature in such way that the resemble relationship and the resemble image file are displayed below the respective photograph.

If the user has more than one child, the user can create more than one child profile through the user account. More specifically, once the user account access the present invention, the user account can select a new child profile feature of the present invention in order to create the additional child profiles. The control software then prompts the user account to upload the child profile data for each of the additional child profiles so that the additional child profiles can be created and stored within the user account. The number of additional child profiles is not limited to a specific number, and the user account can create any number of additional child profiles as long as each of the additional child profiles is related to a specific child. Additionally, the user account can also select in between each of the child profiles to individually access each of the child profiles.

Once the user account access the user account through the email address and the password, the control software displays a plurality of additional features to the user account through the at least one child profile. The plurality of additional features of the present invention comprises a slideshow feature, a view photo feature, an event feature, a photo editing feature, a monthly progress feature, a compare growth feature, a daily diary feature, and a profile upload feature. The control software prompts the user account to select a specific feature from the plurality of additional features as the control software executes the specific feature for the at least one child profile.

Each of the plurality of additional features can be individually selected by the user account and executes a unique output for the present invention, where the output for each of the plurality of additional features is independent from each other. The control software also prompts the user account to interact with the other user account through a request of interaction, a secondary user account request, and a group feature, where the request of interaction, the secondary user account request, and the group feature function independent from one another.

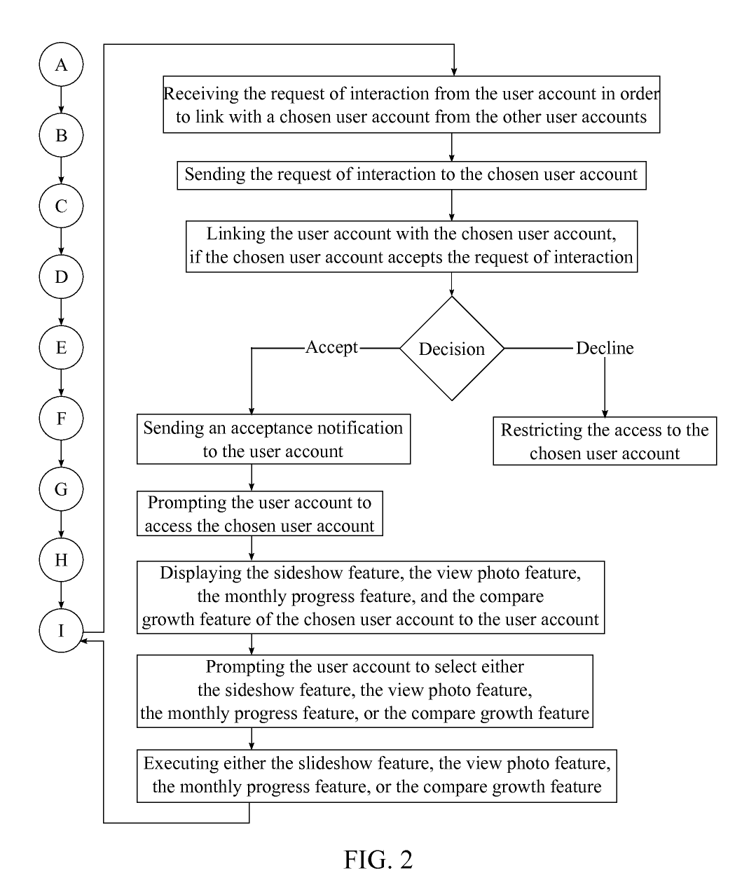

In reference to FIG. 2, the user account can also connect with the other user accounts in order to achieve the social networking aspect of the present invention as the user account is able to see the other user account through the present invention. The social aspect of the present invention allows the user account to interact with other user account so that user account is able to get good suggestions and valuable tip from other parents about how to maintain a quality care for the child. The control software allows the user account to interact with the other user accounts through the request of interaction. More specifically, the user account selects a chosen user account from the other user accounts. Once the user account selects the chosen user account, the control software receives the request of interaction from the user account in order to link with the chosen user account. Then the control software sends the request of interaction to the chosen user account. Once the chosen user account receives the request of interaction from the user account, the user of the chosen user account can accept or decline the request of interaction.

If the chosen user account accepts the request of interaction from the user account, the control software links the user account with the chosen user account and sends an acceptance notification to the user account. Then the user account can access the chosen user account, where the slideshow feature, the view photo feature, the monthly progress feature, and the compare growth feature of the chosen user account are displayed to the user account. The control software then prompts the user account to select either the slideshow feature, the view photo feature, the monthly progress feature, or the compare growth feature of the chosen user account. Depending on the selection of the user account, the control software executes either the slideshow feature, the view photo feature, the monthly progress feature, or the compare growth feature for the user account. If the chosen user account declines the request of interaction from the user account, the control software does not link the user account with the chosen user account, where the user account is restricted from the slideshow feature, the view photo feature, the monthly progress feature, and the compare growth feature of the chosen user account.

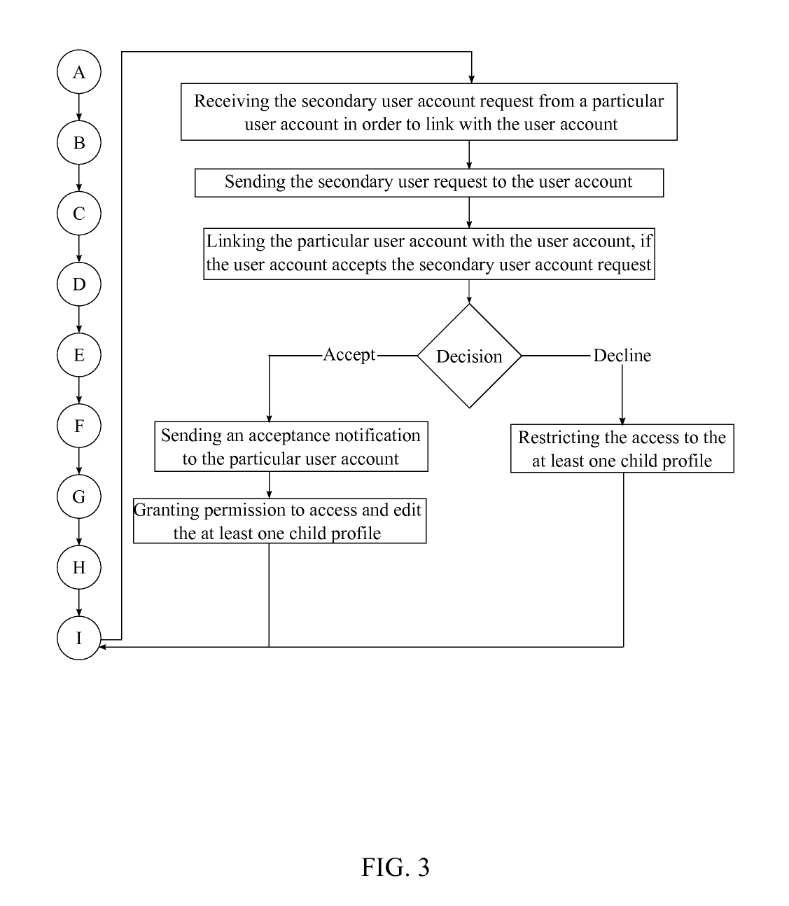

In reference to FIG. 3, the control software also allows the user account to interact with the other user accounts through the secondary user account request. More specifically, the control software first receives the secondary user account request from a particular user account of the other user accounts, where the particular user account requests to link with the user account so that the particular user account can also edit and access the at least one child profile. The particular user account of the present invention is preferably created by the spouse of the user account, grandparents of the child, siblings of the child, or any other person that has important relationship to the child. The control software then sends the secondary user account request to the user account. Once the user account receives the secondary user account request from the particular user account, the user account can accept or decline the secondary user account request.

If the user account accepts the secondary user account request from the particular user account, the control software links the particular user account with the user account and sends an acceptance notification to the particular user account. Then the particular user account is granted permission to access and edit the at least one child profile. Even though the particular user account is able to access and edit the at least one child profile, the user account sets the privacy settings for the particular user account, where the privacy settings determine the amount of control that the particular user account is empowered. If the user account declines the secondary user account request from the particular user account, the control software does not link the particular user account with the user account, denying access to the at least one child profile.

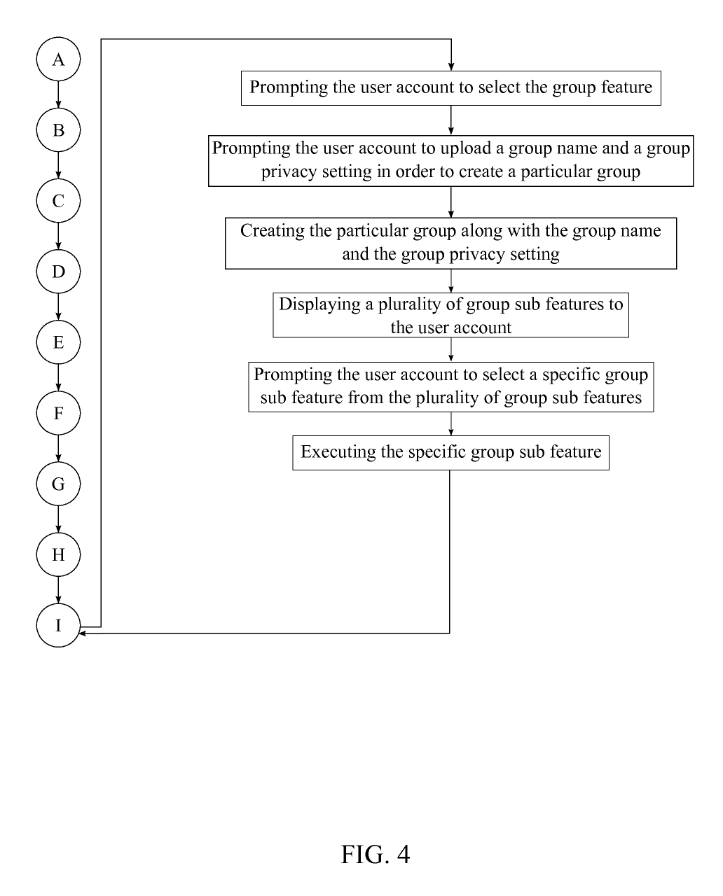

In reference to FIG. 4, the control software also allows the user account to interact with the other user accounts through the group feature, where the control software prompts the user account to select the group feature. More specifically, the control software prompts the user account to upload a group name and a group privacy setting in order to create a particular group for the at least one child profile. Then the control software creates the particular group along with the group name and according to the group privacy setting. The group privacy setting enables the user account either make the particular group private or public. The control software then displays a plurality of group sub features to the user account through the particular group, where the plurality of group sub features comprises a group edit feature, a manage people feature, a group event feature, a group photo feature, a message feature, and a picture feature. The user account can select a specific group sub feature from the plurality of group sub features in order to execute the specific group sub feature, where the plurality of group sub features functions independently from one another. The group edit feature enables the user account to edit information on the particular group so that the user account can update the particular group at any desired time. The manage people feature allows the user account invite other user account into the particular group and delete already existing other user account from the particular group. The group event feature allows the user account to create events within the particular group, where the created group events are displayed with an event calendar. The picture feature allows the user account to upload pictures into the particular group, where the uploaded pictures are chronologically displayed within the particular group. Even though the uploaded pictures are displayed within the particular group, the user account can view the uploaded pictures through the group photo feature as the group photo feature prompts a separate window in order to display any uploaded pictures within the particular group. The message feature allows the user account to communicate with the other user accounts that are part of the particular group.

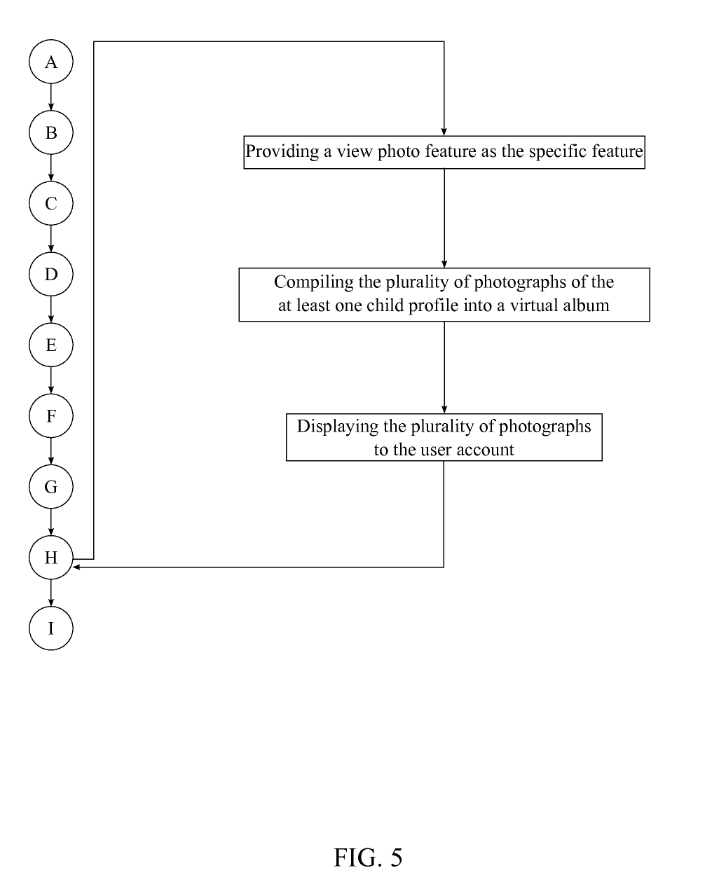

In reference to FIG. 5, providing the view photo feature as the specific feature of the present invention, the control software compiles the plurality of photographs for the at least one profile into a virtual album. Then the plurality of photographs is individually displayed to the user account through the virtual album. The view photo feature of the present invention executes similarly for the at least one child profile of the user account and the chosen user account of the present invention. For example, if a particular user of the present invention wants to view the plurality of photographs of the at least one child profile that are uploaded by the particular user of the user account, the particular user can view the plurality of photographs through the view photo feature of the user account. At the same time, if the particular user wants to view the plurality of photographs of the at least one child profile that are uploaded by a different user of the chosen user account, the particular user can view the plurality of photographs through the view photo feature of the chosen user account.

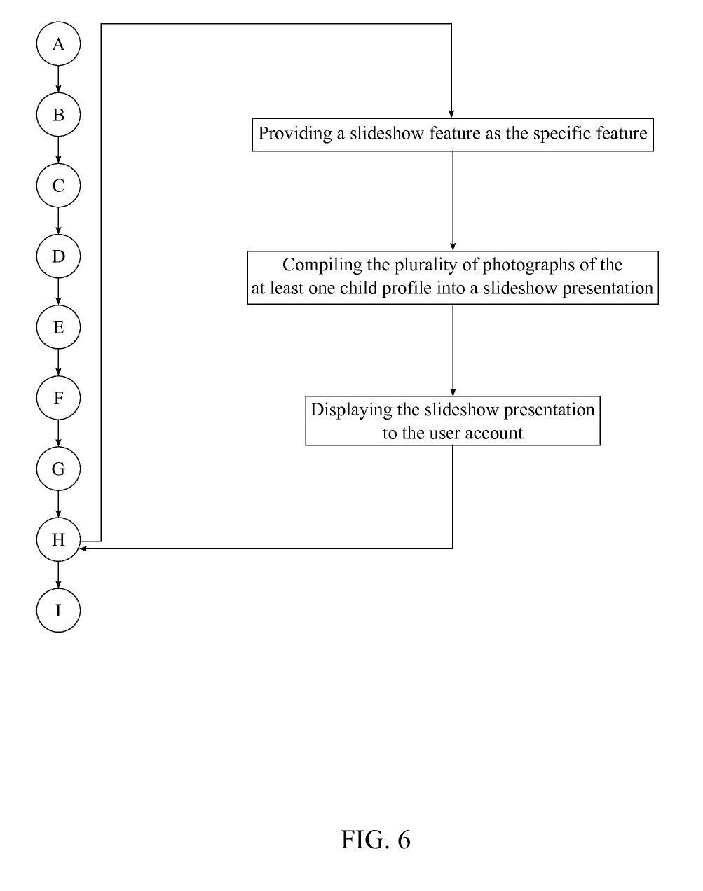

In reference to FIG. 6, providing the slideshow feature as the specific feature of the present invention, the control software compiles the plurality of photographs for the at least one profile into a slideshow presentation. Then the slideshow presentation is displayed to the user account in such way that the plurality of photographs is displayed to the user account through the slideshow presentation. The slideshow feature of the present invention executes similarly for the at least one child profile of the user account and the chosen user account of the present invention. For example, if a particular user of the present invention wants to view the plurality of photographs of the at least one child profile that are uploaded by the particular user of the user account, the particular user can view the plurality of photographs through the slideshow feature of the user account. At the same time, if the particular user wants to view the plurality of photographs of the at least one child profile that are uploaded by a different user of the chosen user account, the particular user can view the plurality of photographs through the slideshow feature of the chosen user account.

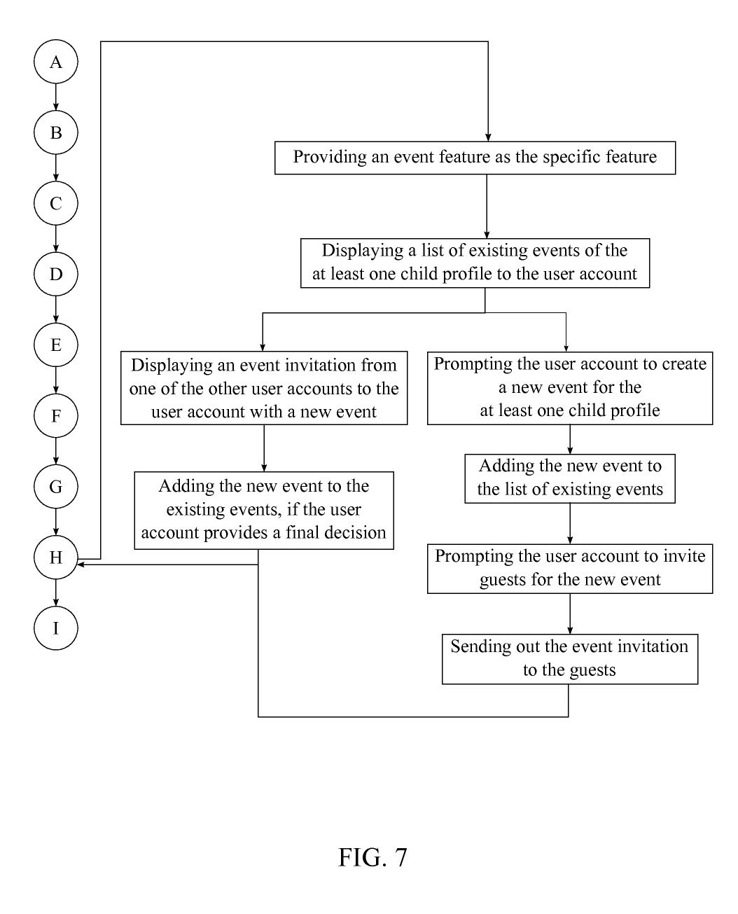

In reference to FIG. 7, providing the event feature as the specific feature of the present invention, the control software displays a list of existing events of the at least one child profile to the user account. The list of existing events of the present invention can be, but is not limited to, birthday events, holiday events, sport activities, religious ceremonies, and any other similar events. The list of existing events can be generally organized into two different groups as the user account becomes a guest or a host. When the user account is invited to a new event from one of the other user accounts, the control software sends an event invitation to the user account. The event invitation which is directly associated with the new event is then displayed to the user account. The control software adds the new event to the list of existing events, if the user account provides a final decision to the event invitation. Otherwise the event invitation stays as the new event every time the user account access the at least one child profile. The final decision to the event invention can be either an acceptance selection, a rejection selection, or an unsure selection. When the user account provides the final decision for the new event, the final decision is recorded within the new event in such way that the host is able to view the final decision. When the user account is the host of a new event, the user account needs to create the new event within the at least one child profile. More specifically, the control software prompts the user account to create the new event for the at least one child profile, and then adds the new event into the list of existing events. Once the new event is added to the list of existing events, the control software prompts the user account to invite guests for the new event with an event invitation. If the invitees are linked to the user account, the user account can invite them through the present invention as the control software sends out the event invitation to those invitees. If the invites are not link to the user account, the user account can invite them through their personal emails as the control software sends out the event invitation to those invitees. When the invitees provide the final decisions to the event, the final decisions are sent to the at least one child profile so that the user account is able to view the final decisions of the invitees.

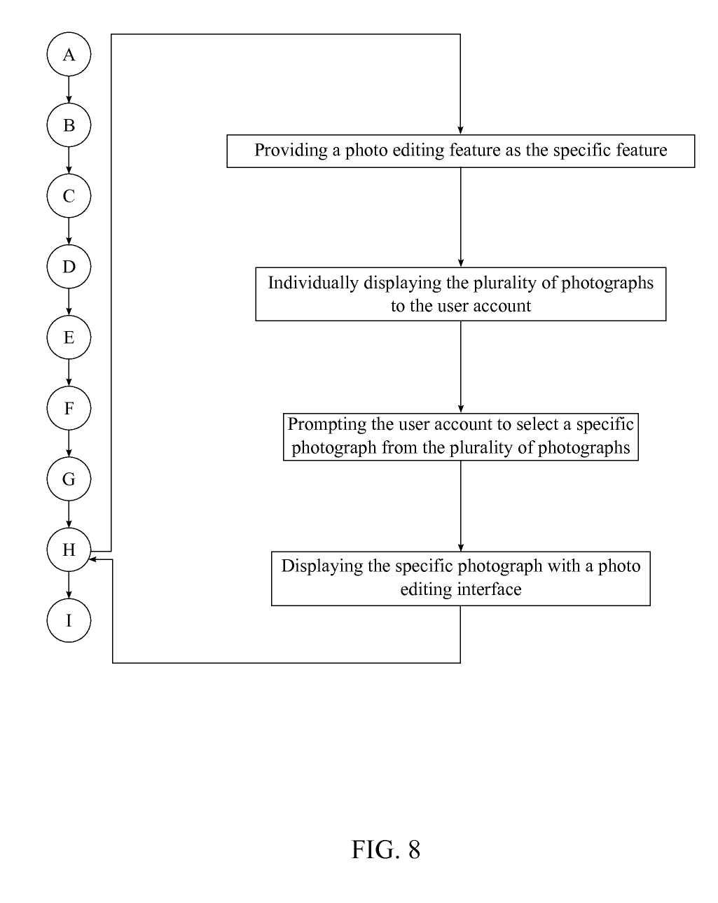

In reference to FIG. 8, providing the view photo editing feature as the specific feature of the present invention, the control software individually displays the plurality of photographs for the user account. Then the control software prompts the user account to select a specific photograph form the plurality of photographs so that the specific photograph can be edited through the present invention. Then the specific photograph is displayed with a photo editing interface in order to edit the specific photograph. The user account is able to adjust the specific photograph according to the user's preference as the photo editing interface provides a plurality of editing tools, wherein the plurality of editing tools comprises an effects tool, a sticker tool, an orientation tool, a resize tool, a warmth tool, a crop tool, a brightness tool, a contrast tool, a saturation tool, a sharpness tool, a draw tool, a text tool, a redeye tool, a whiten tool, and a blemish tool. Once the user account finishes editing the specific photograph, the control software saves only the edited version of the specific photograph within the present invention replacing the older version of the specific photograph.

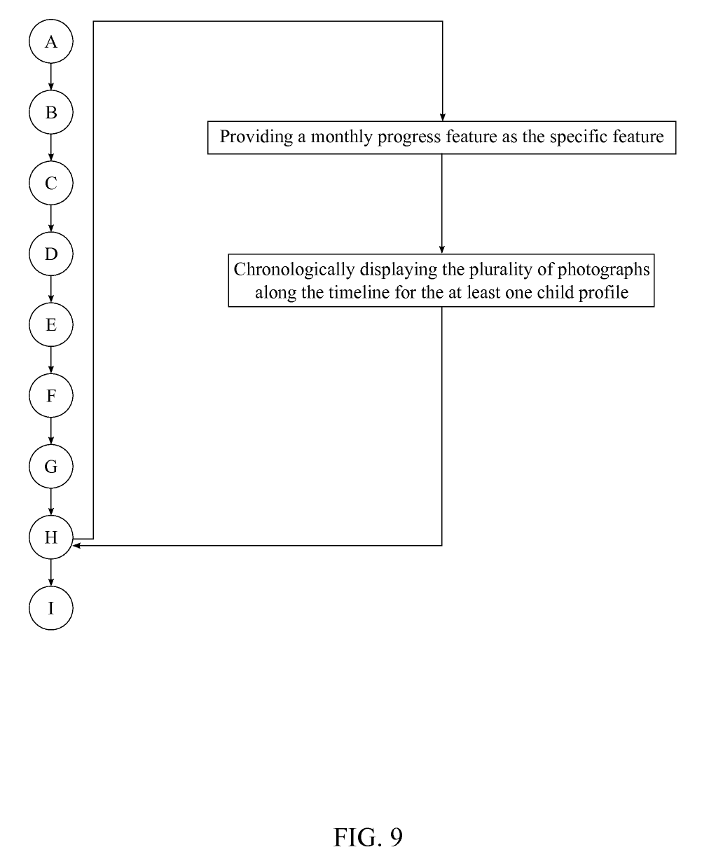

In reference to FIG. 9, providing the monthly progress feature as the specific feature of the present invention, the control software chronologically displays the plurality of photographs along the timeline for the at least one child profile. Since the timeline directly depends on the plurality of photographs, the user account is able to see the growth progress of the child through the monthly progress feature of the present invention. The monthly progress feature of the present invention executes similarly for the at least one child profile of the user account and the chosen user account of the present invention. For example, if a particular user of the present invention wants to view the monthly progress of one his or her child, the particular user can select the monthly progress feature of the at least one child profile. At the same time, if the particular user wants to view the monthly progress for the at least one child profile of the chosen user account, the particular user can select the monthly progress feature of the chosen user account.

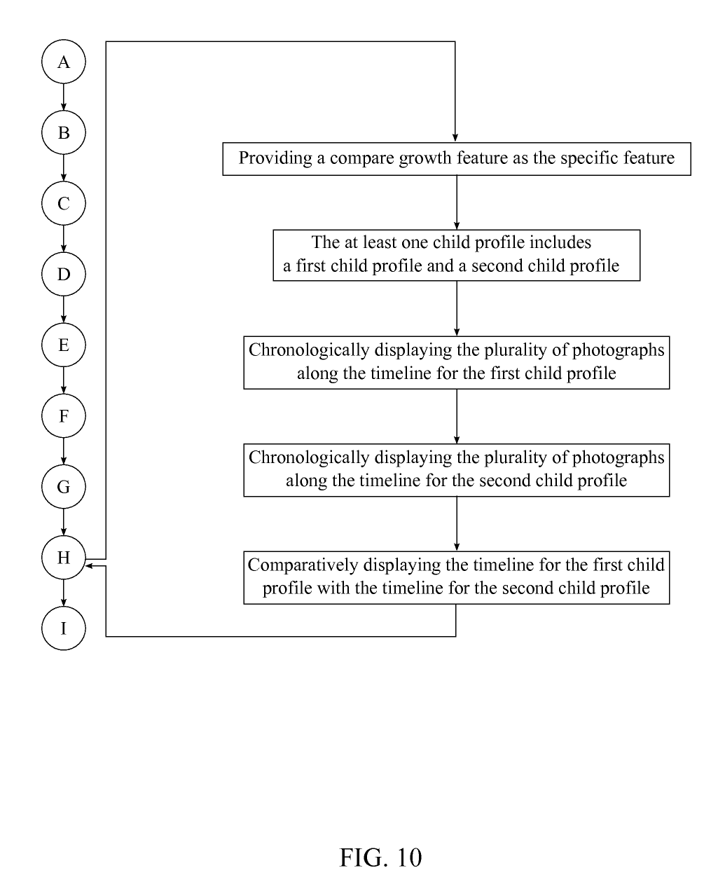

In reference to FIG. 10, providing the compare growth feature as the specific feature of the present invention, the control software chronologically displays the plurality of photographs along the timeline for the at least one child profile, wherein the at least one child profile includes a first child profile and a second child profile. More specifically, the control software chronologically displays the plurality of photographs along the timeline for the first child profile and the second child profile in such way that the timeline for the first child profile is comparatively displayed with the second child profile. The compare growth feature of the present invention executes similarly for the at least one child profile of the user account and the chosen user account of the present invention. For example, a user account can select the compare growth feature which displays the timeline for the first child profile and the second child profile of the user account, and the user account can also select the compare growth feature of the chosen user account which displays the timeline for the first child profile and the second child profile of the chosen user account.

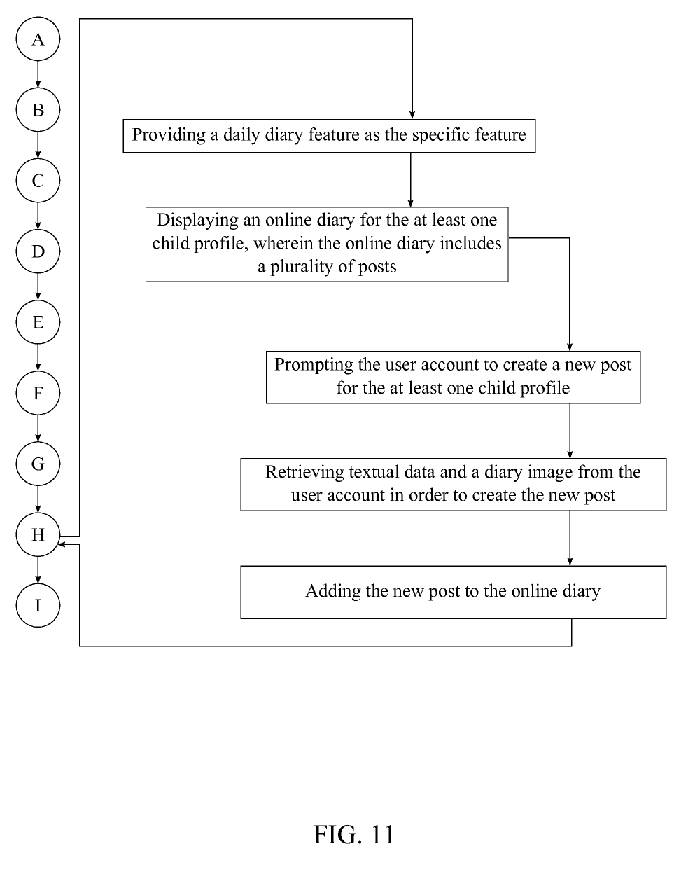

In reference to FIG. 11, providing the daily diary feature as the specific feature of the present invention, the control software displays an online diary for the at least one child profile, where the online diary includes a plurality of posts. The online diary functions as a task calendar so that the user account is able to save a specific post with respect to a specific date within the online diary. When the user account needs to create a new post for the at least one child profile, the user account needs select the specific date and provide textual data and a dairy image. Then the control software receives the textual data, the diary image, and the specific data in order to create the new post. Once the control software creates the new post, the new post is added to the online diary of the present invention so that the user account is able to view them at later instances. The user account can also store medical records of their children within the at least one child profile. The medical records of each child are stored within their respective child profile and can only be accessed by the user account. The medical records are preferably stored within the online diary of the present invention.

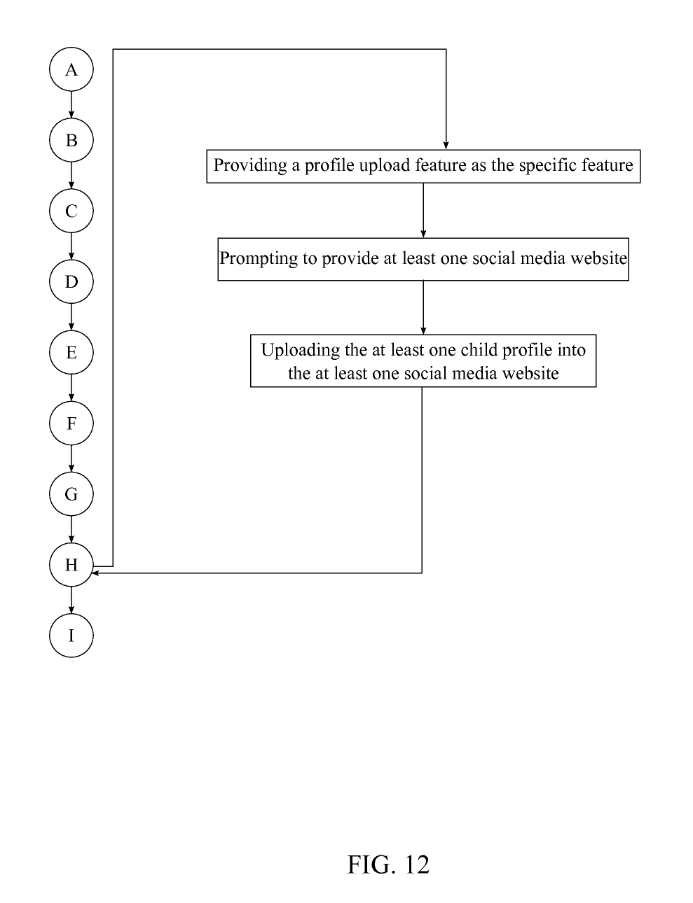

In reference to FIG. 12, providing the profile upload feature as the specific feature of the present invention, the control software prompts the user account of the present invention to provide at least one social media website. Once the control software receives the at least one social media website, the control software uploads the at least one child profile into the at least one social media website in such way that the control software creates a separate account for the at least one child profile.

The control software also prompts the user account to export the plurality of pictures of the virtual album and the list of existing events to other social media website through an upload link within the present invention, where the upload link directly connects to a user profile of a social media website. Similarly, the user account can also import pictures, events, and videos to the at least one child profile from the user profile of the social media website.

When the children get to the first predetermine age, preferably age 13, the children can partially control their profiles as their parent oversee the child profiles. During the first predetermine age, if the children decides to join or create a group through the group feature, the at least one child profile and the user account are notified by the control software so that the parents are able to monitor the activities of the at least one child profile. When the children get to the second predetermine age, preferably age 18, the children take over the complete control of their child profiles. When the at least child profile is completely controlled by the children, the children can also execute the at least one child profile similar to the user account. As a result, the present invention is able to provide a complete life history for the children. When those children become adults and have kids of their own, they can create child profiles for their kids. This process creates continues cycle within the present invention for generation's history, wherein both the current users and the future users of the present invention are able to access the generation history.

Although the invention has been explained in relation to its preferred embodiment, it is to be understood that many other possible modifications and variations can be made without departing from the spirit and scope of the invention as hereinafter claimed.

What is claimed is:

1. A method for maintaining a parental control online profile for a child through a non-transitory computer-readable medium by executing computer-executable instruction comprises the steps of:
(A) providing a user account and other user accounts, wherein each of the other user accounts is similarly managed to the user account;
(B) prompting the user account to create at least one child profile with a child profile data;
(C) adding the at least one child profile to the user account;
(D) receiving a plurality of photographs for the at least one child profile, wherein each of the plurality of photographs includes a selected date and a geographical location;
(E) chronologically organizing the plurality of photographs by their selected date in order to create a timeline for the at least one child profile;
(F) displaying a plurality of additional features to the user account through the at least one child profile, wherein the plurality of additional features comprises a slideshow feature, a view photo feature, an event feature, a photo editing feature, a monthly progress feature, a compare growth feature, a daily diary feature, and a profile upload feature;
(G) prompting the user account to select a specific feature from the plurality of additional features;
(H) executing the specific feature for the at least one child profile; and
(I) prompting the user account to interact with the other user accounts through a request of interaction, a secondary user account request, and a group feature.

2. The method for maintaining a parental control online profile for a child through a non-transitory computer-readable medium by executing computer-executable instruction as claimed in claim 1 comprises:
wherein the child profile data includes a child name, a child gender, a child nickname, and a child birthday.

3. The method for maintaining a parental control online profile for a child through a non-transitory computer-readable medium by executing computer-executable instruction as claimed in claim 1 comprises the steps of:
receiving the request of interaction from the user account in order to link with a chosen user account of other user accounts;
sending the request of interaction to the chosen user account; and
linking the user account with the chosen user account,
if the chosen user account accepts the request of interaction from the user account.

4. The method for maintaining a parental control online profile for a child through a non-transitory computer-readable medium by executing computer-executable instruction as claimed in claim 3 comprises the steps of:
sending an acceptance notification to the user account,
if the chosen user account accepts the request of interaction from the user account;
prompting the user account to access the chosen user account;
displaying the slideshow feature, the view photo feature, the monthly progress feature, and the compare growth feature of the chosen user account to the user account;
prompting the user account to select either the slideshow feature, the view photo feature, the monthly progress feature, or the compare growth feature of the chosen user account; and
executing either the slideshow feature, the view photo feature, the monthly progress feature, or the compare growth feature for the user account.

5. The method for maintaining a parental control online profile for a child through a non-transitory computer-readable medium by executing computer-executable instruction as claimed in claim 1 comprises the steps of:
receiving the secondary user account request from a particular user account of other user accounts in order to link with the user account;
sending the secondary user account request to the user account; and
linking the particular user account with the user account,
if the user account accepts the secondary user account request from the particular user account.

6. The method for maintaining a parental control online profile for a child through a non-transitory computer-readable medium by executing computer-executable instruction as claimed in claim 5 comprises the steps of:
sending an acceptance notification to the particular user account,
if the user account accepts the secondary user account request from the user particular account; and
granting permission to access and edit the at least one child profile.

7. The method for maintaining a parental control online profile for a child through a non-transitory computer-readable medium by executing computer-executable instruction as claimed in claim 1 comprises the steps of:
prompting the user account to select the group feature;
prompting the user account to upload a group name and a group privacy setting in order to create a particular group;
creating the particular group along with the group name and the group privacy setting;
displaying a plurality of group sub features to the user account through the particular group, wherein the plurality of group sub features comprises a group edit feature, a manage people feature, a group event feature, a group photo feature, a message feature, and a picture feature;
prompting the user account to select a specific group sub feature from the plurality of group sub features; and
executing the specific group sub feature.

8. The method for maintaining a parental control online profile for a child through a non-transitory computer-readable medium by executing computer-executable instruction as claimed in claim 1 comprises the steps of:
providing the view photo feature as the specific feature;
compiling the plurality of photographs of the at least one child profile into a virtual album; and
individually displaying the plurality of photographs to the user account through the virtual album.

9. The method for maintaining a parental control online profile for a child through a non-transitory computer-readable medium by executing computer-executable instruction as claimed in claim 1 comprises the steps of:
providing the slideshow feature as the specific feature;
compiling the plurality of photographs of the at least one child profile into a slideshow presentation; and
displaying the slideshow presentation to the user account.

10. The method for maintaining a parental control online profile for a child through a non-transitory computer-readable medium by executing computer-executable instruction as claimed in claim 1 comprises the steps of:
providing the event feature as the specific feature; and
displaying a list of existing events of the at least one child profile to the user account.

11. The method for maintaining a parental control online profile for a child through a non-transitory computer-readable medium by executing computer-executable instruction as claimed in claim 8 comprises the steps of:
displaying an event invitation from one of the other user accounts to the user account, wherein the event invitation is associated with a new event; and
adding the new event to the list of existing events,
if the user account provides a final decision to the event invitation.

12. The method for maintaining a parental control online profile for a child through a non-transitory computer-readable medium by executing computer-executable instruction as claimed in claim 8 comprises the steps of:
prompting the user account to create a new event for the at least one child profile;
adding the new event to the list of existing events;
prompting the user account to invite guests for the new event with an event invitation; and
sending out the event invitations to the guests.

13. The method for maintaining a parental control online profile for a child through a non-transitory computer-readable medium by executing computer-executable instruction as claimed in claim 1 comprises the steps of:
providing the photo editing feature as the specific feature;
individually displaying the plurality of photographs for the user account;
prompting the user account to select a specific photograph from the plurality of photographs; and
displaying the specific photograph with a photo editing interface in order to edit the specific photograph.

14. The method for maintaining a parental control online profile for a child through a non-transitory computer-readable medium by executing computer-executable instruction as claimed in claim 1 comprises the steps of:
providing the monthly progress feature as the specific feature; and
chronologically displaying the plurality of photographs along the timeline for the at least one child profile.

15. The method for maintaining a parental control online profile for a child through a non-transitory computer-readable medium by executing computer-executable instruction as claimed in claim 1 comprises the steps of:
providing the compare growth feature as the specific feature;
wherein the at least one child profile includes a first child profile and a second child profile;
chronologically displaying the plurality of photographs along the timeline for the first child profile;
chronologically displaying the plurality of photographs along the timeline for the second child profile; and
comparatively displaying the timeline for the first child profile with the timeline for the second child profile.

16. The method for maintaining a parental control online profile for a child through a non-transitory computer-readable medium by executing computer-executable instruction as claimed in claim 1 comprises the steps of:
providing the daily diary feature as the specific feature; and
displaying an online diary for the at least one child profile, wherein the online diary includes a plurality of posts.

17. The method for maintaining a parental control online profile for a child through a non-transitory computer-readable medium by executing computer-executable instruction as claimed in claim 14 comprises the steps of:
prompting the user account to create a new post for the at least one child profile;
retrieving textual data and a dairy image from the user account in order to create the new post; and
adding the new post to the online diary.

18. The method for maintaining a parental control online profile for a child through a non-transitory computer-readable medium by executing computer-executable instruction as claimed in claim 1 comprises the steps of:
providing the profile upload feature as the specific feature;
prompting to provide at least one social media website; and
uploading the at least one child profile into the at least one social media website.
